(19) United States
(12) Patent Application Publication
(10) Pub. No.: US 2008/0020773 A1
(43) Pub. Date: Jan. 24, 2008

(54) WIRELESS COMMUNICATION DEVICE AND METHOD FOR MANAGING THE CALL ROUTING FOR MULTIPLE SERVICES EACH RESPECTIVELY ASSOCIATED WITH A CORRESPONDING ONE OF MULTIPLE SETS OF STORED SUBSCRIBER IDENTITY INFORMATION

(75) Inventors: GREG R. BLACK, VERNON HILLS, IL (US); RAFAEL COLORADO, LONG GROVE, IL (US); MANOJ PUCHADATH RAGHAVAN, GRAYSLAKE, IL (US)

Correspondence Address: MOTOROLA INC, 600 NORTH US HIGHWAY 45, W4 - 39Q, LIBERTYVILLE, IL, 60048-5343, US

(73) Assignee: MOTOROLA, INC., LIBERTYVILLE, IL (US)

(21) Appl. No.: 11/459,196

(22) Filed: Jul. 21, 2006

(51) Int. Cl. H04M 1/00; H04Q 7/20

(52) U.S. Cl. 455/445; 455/558

(57) ABSTRACT

A wireless communication device and method is provided for managing the call routing for multiple services each respectively associated with a corresponding one of multiple sets of stored subscriber identity information. The wireless communication device includes wireless communication circuitry, that enables the wireless communication unit to communicate through at least a first wireless communication service and a second wireless communication service and a subscriber identity information memory that stores at least a first subscriber identity information associated with the first wireless communication service and a different second subscriber identity information associated with the second wireless communication service. An indication is received regarding which of a selected one of the first wireless communication service and the second wireless communication service the wireless communication device is to employ. If the selected one of the first wireless communication service and the second wireless communication service is different from a currently employed wireless communication service, then a message is transmitted to the currently employed wireless communication service indicating that the currently employed wireless communication service is to forward all calls to the subscriber identity information associated with the selected one of the first wireless communication service and the second wireless communication service.

### BACKGROUND OF THE INVENTION

1. Field of the Invention

The present invention relates to wireless communication devices and, more specifically, to a wireless communication device that employs more than one sets of stored subscriber identity information, such as multiple SIMs.

2. Background of the Invention

Global System for Mobile (GSM) communications is one example of a technology standard that is used by many mobile telephone networks throughout the world. GSM technology is in use by more than one fifth of all current wireless systems world-wide. Mobile telephones, such as GSM-based telephones, employ a Subscriber Identity Module (SIM) that stores much of the user specific data used to connect a mobile telephone with a network and/or with a particular network account, relative to a particular service provider. A SIM can be a smart card that stores such information as: the telephone number of the subscriber, encoded network identification details, the PIN and other user data such as the user's specific telephone book. In other instances, a SIM might take the form of a key fob. Still other forms are possible, and does not preclude the information from being more directly integrated as part of the communication device.

The SIM's nature, when in card form, and the manner in which it attaches to a telephone enables a user's SIM to be moved from telephone to telephone. The SIM includes a substantial amount of the user's specific information required to associate the telephone with a specific user account relative to the network. A user may selectively use different devices to access a network by selectively installing the SIM containing the user's information in one of the different devices. In some instances, a user may selectively use different SIMs in a telephone to allow the telephone to be used operate in different operational modes, and/or in association with different user accounts and/or network providers. For example, a user might want to use one telephone for both personal and business calls, but will want the charges for each to be entered in different billing statements. To do this, the user might have a SIM associated with a business account and a SIM associated with a personal account, depending on the desired use. Also, the user might wish to use a single mobile telephone in different countries and, thus, might install a SIM associated with a North American network service provider for use while in North America, but might install a SIM associated with a European network service provider for use while in Europe.

Some designs allow two or more SIMs to be installed in a telephone at the same time. When changing between different wireless services, at least some current multi-SIM telephones require the user to power down the telephone being used, and then switch from the currently used service associated with a first one of the two or more SIMs to the service associated with the other one of the two or more SIMs. Such a system for SIM selection can be cumbersome and time consuming. Where a physical switch is used to selectively couple one of the two or more SIMs to the rest of the telephone circuitry, it can also be difficult in some instances to effect a selection via the switch if a small physical switch is used.

Most wireless devices have the ability to determine quality indicators of wireless services. For example, if a wireless device measures and reports an “RX-QUAL” message to a service indicating the quality of the received signal, and this measurement is therefore available to the device for other purposes. Also, a device can send an “Advice of Charge” request to a service and receive a response that indicates the current amount that the service would charge the user's account for communicating with the service. Also, there are ways in which a wireless device may determine a service preference from channel quality aspects of a wireless communication cell. For example, the device may correlate received signal level or quality, communication, transmitter level or quality, noise or interference level, or communication distance to service preference. It may infer communication distance using properties employed in the communication cell such as the transmitter timing advance (used in GSM) or receiver timing delay which vary according to the signal propagation delay, or by the receiver or transmitter level, which generally varies in inverse proportion to the signal propagation loss. The device may also request quality information from the service which is not normally used in by the device for communication, such as a measure of receiver quality or channel capacity at the communication cell. The device may also request information about available service types, such as voice, messaging, and data. A wireless device may also determine service preference by power dissipation. Where a user has multiple associated services to select between, theoretically the corresponding information could be obtained from each of the associated services.

However with the increased automation and potentially more frequent switching between and/or selection of one of multiple services, the present inventors have recognized that it would be beneficial to manage call routing for each of the available services, associated with the multiple sets of stored subscriber identity information, to the particular service which is presently selected, where the receipt of messages via each of the services could be received by the wireless communication device via the currently selected active service. Such call routing management could be facilitated by maintaining an appropriate call forwarding status for each of the available communication services.

The present inventors have further recognized, it would be beneficial if a wireless device having multiple sets of subscriber identity information, respectively associated with one of a plurality of corresponding wireless communication services took advantage of the information available to it regarding signal quality and price, or some other selection criteria, herein referred to as value, deemed to be beneficial to the user in the automatic selection of which one of the multiple sets of subscriber identity information to use for accessing at least one of a plurality of communication services, such as between communication services of the same or differing types. Such a wireless device could provide a selection of services between a plurality of communication services in a manner which is more optimal relative to one or more system or user selected criteria, such as cost, quality, or other still further criteria, and/or preferred combination of a plurality of different criteria, while maintaining call routing for one or more of the available services to the service, which is presently selected.

### SUMMARY OF THE INVENTION

In one aspect, the invention is a method for controlling a wireless communication device, that includes wireless communication circuitry, that enables the wireless communication unit to communicate through at least a first wireless communication service and a second wireless communication service and a subscriber identity information memory that stores at least a first subscriber identity information associated with the first wireless communication service and a different second subscriber identity information associated with the second wireless communication service. An indication is received regarding which of a selected one of the first wireless communication service and the second wireless communication service the wireless communication device is to employ. If the selected one of the first wireless communication service and the second wireless communication service is different from a currently employed wireless communication service, then a message is transmitted to the currently employed wireless communication service indicating that the currently employed wireless communication service is to forward all calls to the subscriber identity information associated with the selected one of the first wireless communication service and the second wireless communication service.

In another aspect, the invention is a wireless communication device that includes a transmitter or receiver unit, a subscriber identity information memory, and a controller. The controller includes a call forwarding module that is adapted to detect a selected one of the first wireless communication service and the second wireless communication service. If the selected one of the first wireless communication service and the second wireless communication service is different from a currently employed wireless communication service, then a message is transmitted to the currently employed wireless communication service indicating that the currently employed wireless communication service is to forward all calls to the subscriber identity information associated with the selected one of the first wireless communication service and the second wireless communication service.

These and other aspects of the invention will become apparent from the following description of the preferred embodiments taken in conjunction with the following drawings. As would be obvious to one skilled in the art, many variations and modifications of the invention may be effected without departing from the spirit and scope of the novel concepts of the disclosure.

### BRIEF DESCRIPTION OF THE FIGURES OF THE DRAWINGS

FIG. 1A is a top perspective view of a wireless communication device in a partially open position, which is adapted for receiving subscriber identity information corresponding to a plurality of wireless communication services, in accordance with at least one embodiment of the present invention.

FIG. 1B is a plan view of the wireless communication device shown in FIG. 1, in a more fully open position.

FIG. 2 is a block diagram of a wireless communication device showing representative elements that may be employed in accordance with several embodiments of the invention.

FIG. 3 is a state diagram that may be employed as part of a controller for use in a wireless communication device according to at least some of the embodiments disclosed herein.

FIG. 4 is a flow chart showing one method of call forwarding between two wireless services, in accordance with at least one embodiment of the present invention.

FIG. 5 is a flow chart showing one method of selecting between two wireless services, in accordance with at least one embodiment of the present invention.

### DETAILED DESCRIPTION OF THE INVENTION

A preferred embodiment of the invention is now described in detail. Referring to the drawings, like numbers indicate the same or like parts throughout the views. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.”

In one embodiment, a wireless communication device is provided, such as a mobile telephone having two, or more, stored subscriber identity information, which in the illustrated embodiment takes the form of a Subscriber Identity Module (SIM), which may be received by a corresponding number of SIM sockets with the telephone operable with the subscriber identity information of either SIM. Selection of the SIM may be accomplished through the use of dedicated keys, soft keys, menu choice, or multiple “send” keys such that the subscriber identity is selected at call initiation. Un-registering with one service and registering with another service may be done without powering down. For standby operation, a SIM selecting circuit can be automatic to minimize the expected service cost of incoming calls based on location, available networks, or advice of charge information, or to select the better channel quality, service type. When service is changed from a first SIM identity to a new SIM the telephone may execute the following steps: 1) While still registered on the first SIM, determine the serving cell, network frequency, and network time thereby allowing the bypassing of these steps when reregistering; 2) request the network to forward calls to the new identity, 3) unregister, 4) register with the second identity, bypassing the determination of serving cell, network frequency and network time; 5) If the service is changed by a “send” key, the telephone initiates the telephone call. In one embodiment, after the call is terminated the telephone may then execute steps 1-4 to go back to the first SIM registration. In one embodiment, the telephone may execute this sequence (except for step 5—making the call) in order to obtain advice of charge information, and then make the call with the SIM having the lowest rate. In another embodiment, the wireless communication device may register with both SIMs regularly and/or substantially simultaneously to determine which network provides better call performance (i.e. signal strength, interference, or power drain) and make a call with the SIM having the best performance. The device may determine call performance from call parameters available from registration (i.e. received level or quality, transmitted level, transmitter timing advance, power drain) or by requesting performance parameters from the service (i.e. received level or quality at the communication cell, or available service types).

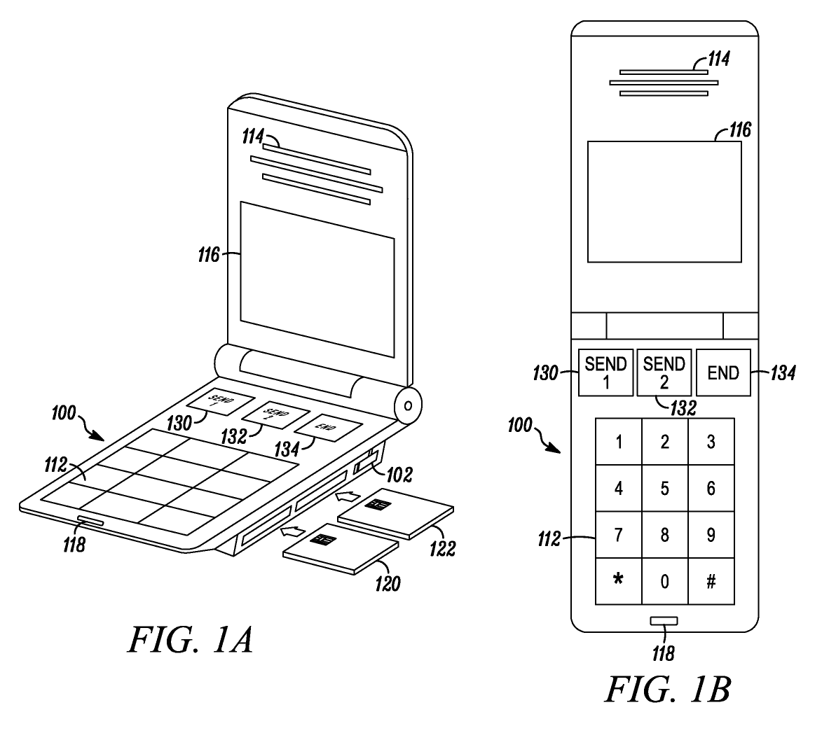

As shown in FIGS. 1A and 1B, a wireless communication device 100 (e.g., a cellular telephone) is provided that includes an on-off switch 102, a keypad input 112, a speaker 114, a display 116 and a microphone 118. The telephone also includes a first SIM 120, which stores a first subscriber identity information, and a second SIM 122, which stores a second subscriber identity information. The wireless communication device 100 also includes a first send key 130, or other first send user selectable input, the selection of which by the user causes the wireless communication device 100 to employ the first SIM 120 to register with a first wireless communication service when initiating a call, and a second send key 132, or other second send user selectable input, the selection of which by the user causes the wireless communication device 100 to employ the second SIM 122 to register with a second wireless communication service when initiating a call. The wireless communication device 100 also includes an end key 134 that allow the user to terminate a call.

To make a call, the user would input the telephone number of the person being called with the keypad 112 and then select one of the first send key 130 and the second send key 132 to initiate the call. The system would use the information stored in the first SIM 120 when registering with a wireless service if the first send key 130 was pressed to initiate the call. Alternatively, the system would use the information stored in the second SIM 122 when registering with a wireless service if the second send key 132 was pressed to initiate the call.

While the embodiment shown employs two separate SIMs 120 and 122 in the form of cards to store subscriber identity information, such information could be stored in an internal memory or some other data retaining form if the wireless system employs a wireless communication standard that does not use cards. It is intended that all such embodiments fall within the scope of claims below. While two sets of subscriber identity information in the form of a pair of SIM cards are illustrated, a wireless communication device might employ a number of sets of subscriber identity information, which exceeds the two illustrated, without departing from the teachings of the present invention.

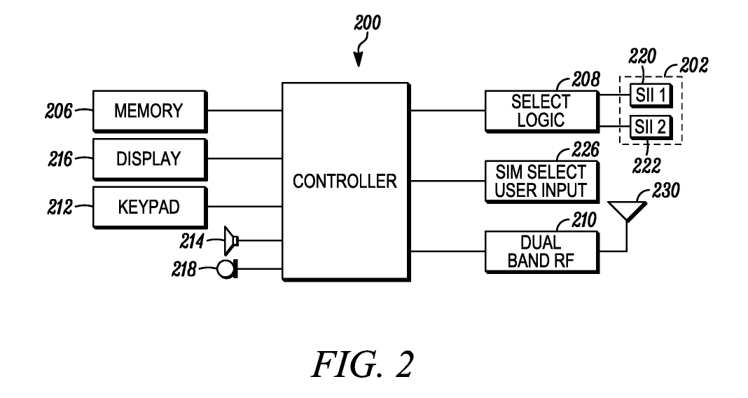

A block diagram of wireless communication circuitry employed in one embodiment is shown in FIG. 2. The wireless communication circuitry includes a controller 200, which can include one or more processing elements such as a microprocessor. The controller 200 receives input from a microphone 218 and outputs sound with a speaker 214. A memory 206, which is similarly coupled to the controller 200, can store subscriber identity information, control code and other data used by the system. The controller 200 further controls a wireless transceiver circuit 210 (a transmitter and receiver unit) that communicates with the aid of an antenna 230. The controller 200 can further monitor power drain. The controller 200 still further receives a user input from an input interface, such as a keypad 212, and presents information to the user with an output interface, such as an LCD display 216. The controller 200 also receives input from a SIM card selection user input 226 (such as the first send key 130, or other send selectable element, and second send key 132, or other send selectable element, disclosed above). The input selection received from the SIM card selection user input 226 is transmitted to a SIM card select logic circuit 208 that relays the subscriber identity information stored in the selected one of the first SIM card 220 and the second SIM card 222 to the controller 200. In the illustrated embodiment, the first SIM card 220 and the second SIM card 222, together form at least part of a subscriber identity information memory 202. It is also possible to use two transceivers and, thereby, remain registered with two services simultaneously.

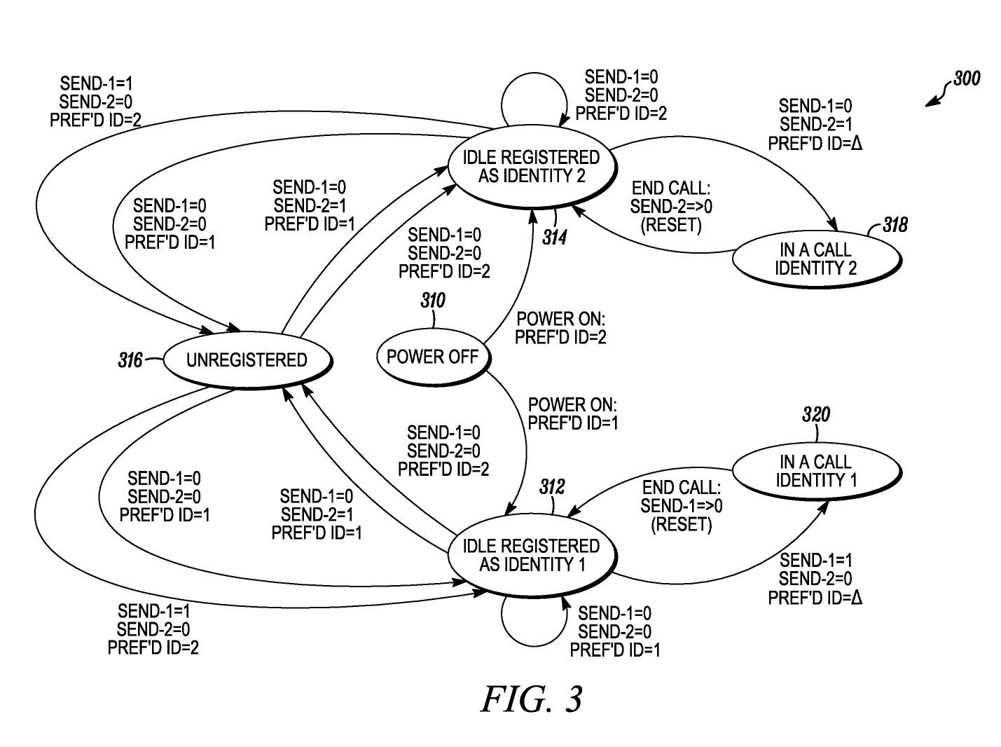

A state diagram 300 of a registration module that may be used in the design of a device embodying the invention is shown in FIG. 3. Initially, the system is in a power off state 310. When the system powers on (e.g., as a result of the on-off switch 102 being turned “on”), the system reads a power on preference from the memory 206. If the preference is for using the wireless service corresponding to the first SIM card 220, then the system enters the first idle registered state 312, in which the system resisters with the first wireless service. If the preference is for using the wireless service corresponding to the second SIM card 222, then the system enters the second idle registered state 314, in which the system registers with the second wireless service.

If the system is in the first idle registered state 312 and no send input is received and if the preferred service is the first service, then the system will stay in the first idle registered state 312. If the preferred service is the second service, then the system will unregister from the first service and enter an unregistered state 316. The system will then enter the second idle registered state 314.

If the system is in the first idle registered state 312 and receives the first send input (i.e., the first send key is asserted) the system will enter a first service call state 320. Upon ending the call, the system will re-enter the first idle registered state 312.

If the system is in the first idle registered state 312 and receives the second send input (i.e., the second send key is asserted), then the system will unregister from the first service and enter an unregistered state 316. The system then will enter the second idle registered state 314, and then will enter a second service call state 318.

If the system is in the second idle registered state 314 and no send input is received and if the preferred service is the second service, then the system will stay in the second idle registered state 314. If the preferred service is the first service, then the system will unregister from the second service and enter an unregistered state 316. The system then will enter the first idle registered state 312.

If the system is in the second idle registered state 314 and receives the second send input (i.e., the second send key is asserted) the system will enter a second service call state 318. Upon ending the call, the system will re-enter the second idle registered state 314.

If the system is in the second idle registered state 314 and receives the first send input (i.e., the first send key is asserted), then the system will unregister from the second service and enter the unregistered state 316. The system then will enter the first idle registered state 312, and then will enter a first service call state 320.

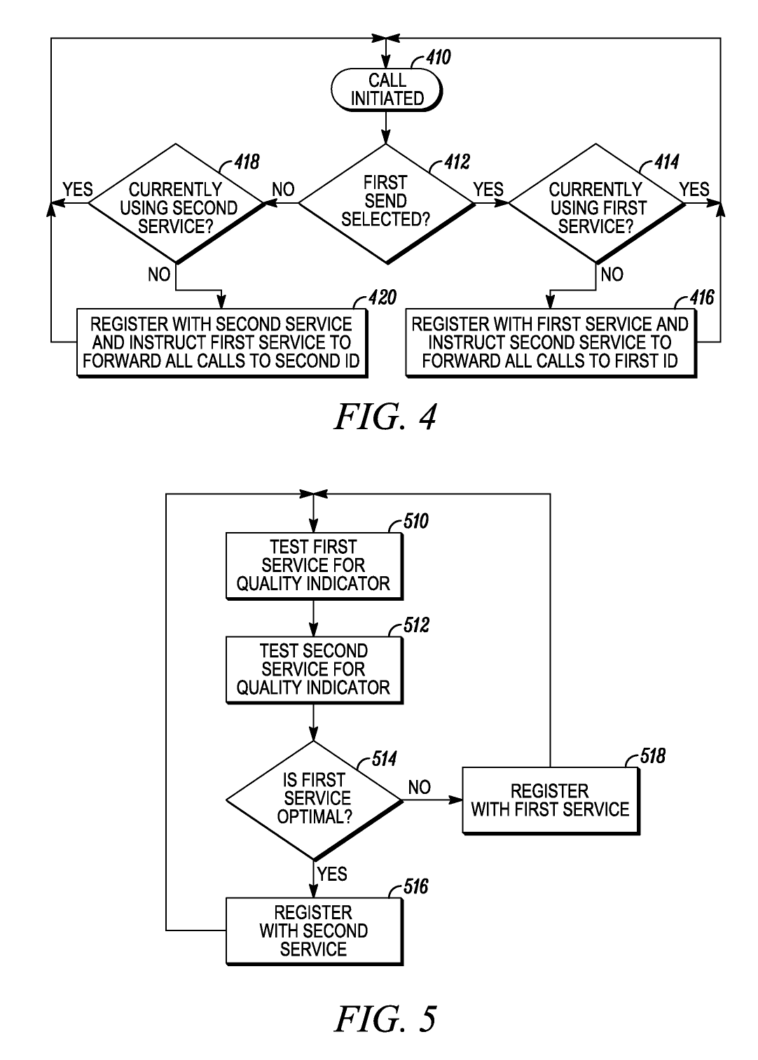

The system may be programmed to forward calls automatically from the service not currently being used to the service currently being used, as shown in FIG. 4. When a call is initiated 410, the system first determines which send key was selected 412 (or which service was selected, in embodiments not employing multiple send keys). If the first send key was selected, the system determines if the first service is currently being used 414 and, if it is, the system returns to step 410. If the second service is currently being used, the system registers with the first service and sends a message to the second service to forward all calls sent to the second user identification (e.g., telephone number) to the first user identification 416. Similarly, if the second send key was selected in step 412, the system determines if the second service is currently being used 418 and, if it is, the system returns to step 410. If the first service is currently being used, the system registers with the second service and sends a message to the first service to forward all calls sent to the first user identification to the second user identification 420.

While in some instances a selection between a first service and a second service can be the result of a manual selection, in other instances it can be the result of a determination and comparison of a preselection criteria relative to each of the available services. One such example is illustrated in FIG. 5. As shown in FIG. 5, the controller can register with a selected one of the first service and the second service, based on an indicator of service quality. The system will test 510 the first service for a quality indicator and test the second service 512 for a quality indicator. If the first service is more optimal 514, then the controller will register with the first service 516, otherwise, it will register with the second service 518.

The device may determine from the first wireless communication service and the second wireless communication service an indicator of wireless communication service channel quality. This can be done by measuring the level of the noise or interference on the communication channel, or by measuring or receiving a quality parameter, “RX-QUAL”, for each wireless communication service. The device will then determine which of the first wireless communication service channel quality and the second wireless communication service channel quality indicates superior quality, based on predetermined criteria (e.g., comparative noise or interference level, “RX-QUAL”, received signal strength, transmit level, channel propagation delay, service response time, service types available, power drain, etc.). If the first wireless communication service channel quality is superior to the second wireless communication service channel quality, then the device will register with the first wireless communication service using the first subscriber identity information. Alternatively, if the second wireless communication service channel quality is superior to the first wireless communication service channel quality, then the system will register with the second wireless communication service using the second subscriber identity information. The device may transmit periodically a plurality of temporally spaced-apart requests for indicators of wireless communication service channel quality both to the first wireless communication service and to the second wireless communication service while the wireless communication device is in a standby mode. In this way, the device will be ready to initiate a call using the more optimal service soon after the user indicates a desire to initiate a call.

Similarly, the device may also request from both the first wireless communication service and the second wireless communication service an indicator of wireless communication service cost, such as by transmitting an “Advice of Charge” message to both wireless communication services. The device will then determine which of the first wireless communication service cost and the second wireless communication service cost is lowest. The device may also determine service cost by other means, such as from the roaming status. If the support for the presently desired network services through the first wireless communication service costs less than through the second wireless communication service, then the device will register with the first wireless communication service using the first subscriber identity information, otherwise it will register with the second wireless communication service using the second subscriber identity information.

Similarly, the device may determine a current location of the wireless communication device and determine which of the first wireless communication service and the second wireless communication service is more optimal for use with the wireless communication device at the current location, based on preselected optimization criteria, which can take into account a combination of criteria (such as a determination of relative low cost and a determination of a minimal signal level sufficient to maintain a call). The device will then register the wireless communication device with the wireless communication service that is more optimal.

The device may periodically poll each wireless communication cell with which the wireless communication device is capable of communicating to detect the information necessary to register with each cell. The device then stores the information necessary for registering with each wireless communication cell in a memory. In this way, the device is able to register quickly with any cell with which it is capable of communicating, if there is a desire to switch from one service to another in support of a desired function involving a network.

The above described embodiments, while including the preferred embodiment and the best mode of the invention known to the inventor at the time of filing, are given as illustrative examples only. It will be readily appreciated that many deviations may be made from the specific embodiments disclosed in this specification without departing from the spirit and scope of the invention. Accordingly, the scope of the invention is to be determined by the claims below rather than being limited to the specifically described embodiments above.

What is claimed is:

1. A method for controlling a wireless communication device, that includes wireless communication circuitry, that enables the wireless communication device to communicate through at least a first wireless communication service and a second wireless communication service and a subscriber identity information memory that stores at least a first subscriber identity information associated with the first wireless communication service and a different second subscriber identity information associated with the second wireless communication service, the method comprising the steps of:
receiving an indication of which of a selected one of the first wireless communication service and the second wireless communication service the wireless communication device is to employ;
if the selected one of the first wireless communication service and the second wireless communication service is different from a currently employed wireless communication service, then transmitting a message to the currently employed wireless communication service indicating that the currently employed wireless communication service is to forward all calls to the subscriber identity information associated with the selected one of the first wireless communication service and the second wireless communication service.

2. The method of claim 1, wherein the step of receiving an indication comprises receiving an input from a user interface.

3. The method of claim 1, further comprising the steps of:
receiving a user input that selects one of at least a first send user selectable input, which indicates that the user desires to communicate through the first wireless communication service, and a second send user selectable input, which indicates that the user desires to communicate through the second wireless communication service; and
registering with the selected one of the first wireless communication service and the second wireless communication service by employing a subscriber identity information corresponding the selected one of the first wireless communication service and the second wireless communication service; and
initiating a communication through the selected one of the first wireless communication service and the second wireless communication service.

4. The method of claim 3, wherein the user input is received from a selected one of a first send key and a second send key.

5. The method of claim 3, further comprising the following step of de-registering from a currently employed wireless communication service and registering with the selected wireless communication service when the selected wireless service is different from the currently employed wireless communication service.

6. The method of claim 1, wherein a determination of which one of a selected one of the first wireless communication service and the second wireless communication service the wireless communication device is to employ for producing a receivable indication thereof includes:
determining an indicator of first wireless communication service performance criteria including at least one of service quality or service cost;
determining an indicator of second wireless communication service performance criteria;
calculating which of the first wireless communication service performance criteria and the second wireless communication service performance criteria is superior, based on a predetermined standard of performance, and:
if the performance criteria of the first wireless communication service is superior to the performance criteria of the second wireless communication service, then registering with the first wireless communication service using the first subscriber identity information; and
if the performance criteria of the second wireless communication service is superior to the performance criteria of the first wireless communication service, then registering with the second wireless communication service using the second subscriber identity information.

7. The method of claim 6, wherein the step of determining indicators of performance criteria includes registering with a service provider.

8. The method of claim 7 wherein a step of determining indicators of performance criteria associated with service quality includes determining one of a channel interference level, a channel noise level, a received signal level, a received signal quality, a transmitted signal level, a receiver timing delay, a transmitter timing advance, a power drain.

9. The method of claim 6, wherein the steps of determining indicators of performance criteria comprise requesting performance criteria information from the service provider.

10. The method of claim 8 wherein the step of requesting indicators of performance criteria associated with service quality further comprise requesting one of available service types, channel capacity, roaming status, receiver signal level at the communication cell, receiver signal quality at the communication cell.

11. The method of claim 7, wherein a step of determining indicators of performance criteria associated with service cost includes transmitting a request to a wireless communication service for one of “Advice of Charge”, available service types, channel capacity, roaming status.

12. The method of claim 6, further comprising the step of transmitting periodically a plurality of temporally spaced-apart requests for indicators of wireless communication performance criteria to each of the first wireless communication service and the second wireless communication service while the wireless communication device is in a standby mode.

13. The method of claim 6, wherein the step of registering with the first wireless communication service using the first subscriber identity information further comprises reading the first subscriber identity information from a first SIM, and wherein the step of registering with the second wireless communication service using the second subscriber identity information further comprises reading the second subscriber identity information from a second SIM.

14. The method of claim 1, wherein a determination of which one of a selected one of the first wireless communication service and the second wireless communication service the wireless communication device is to employ for producing a receivable indication thereof includes:
determining a current location of the wireless communication device;
determining which of the first wireless communication service and the second wireless communication service is more optimal for use with the wireless communication device at the current location, based on preselected optimization criteria; and
registering the wireless communication device with the wireless communication service that is more optimal.

15. The method of claim 14, wherein the optimization criteria is based at least in part on a determination of relative cost.

16. The method of claim 14, wherein the optimization criteria is based at least in part on a determination of a minimal signal level sufficient to maintain a call.

17. A wireless communication device, comprising:
a transmitter or receiver unit including wireless communication circuitry that enables the wireless communication unit to employ at least a first wireless communication service and a second wireless communication service;
a subscriber identity information memory that stores at least a first subscriber identity information associated with the first wireless communication service and a different second subscriber identity information associated with the second wireless communication service; and
a controller including a call forwarding module that is adapted to:
detect a selected one of the first wireless communication service and the second wireless communication service; and
if the selected one of the first wireless communication service and the second wireless communication service is different from a currently employed wireless communication service, then transmitting a message to the currently employed wireless communication service indicating that the currently employed wireless communication service is to forward all calls to the subscriber identity information associated with the selected one of the first wireless communication service and the second wireless communication service.

18. The wireless communication device of claim 17, wherein the subscriber identity information memory comprises a first SIM, and a second SIM.
